(19) United States
(12) Patent Application Publication
(10) Pub. No.: US 2008/0299530 A1
(43) Pub. Date: Dec. 4, 2008

(54) METHODS AND SYSTEMS FOR ONBOARD KARAOKE

(76) Inventor: Colin S. Veitch, Pinecrest, FL (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 12/130,500

(22) Filed: May 30, 2008

Related U.S. Application Data
(60) Provisional application No. 60/924,742, filed on May 30, 2007.

(51) Int. Cl. G09B 19/00

(52) U.S. Cl. 434/307 A

(57) ABSTRACT

The present invention relates to systems and methods for providing karaoke as a form of entertainment upon a ship. In particular, the invention in geared toward providing a unique karaoke experience upon a cruise ship, such that the cruise ship provider may attract karaoke aficionados as customers and provide all of its customers with vet another tantalizing entertainment option.

### CROSS REFERENCE TO RELATED APPLICATIONS

This application claims the benefit, under 35 U.S.C. §119, of provisional U.S. Application Ser. No. 60/924,742, filed May 30, 2007, the entire contents and substance of which is hereby incorporated by reference.

### FIELD OF THE INVENTION

The present invention relates to providing karaoke on a cruise ship. Specifically, the present invention relates to providing karaoke in a self-contained, soundproof cube for use on a cruise ship. The karaoke box comprises a sound system, a karaoke machine, a video camera, a seating area, one or more video screens, and a lighting system. In one embodiment, the karaoke box may be waterproof for placement on the deck of a cruise ship. In another embodiment, the karaoke box is portable.

### BACKGROUND OF THE INVENTION

In recent years, cruise ships have developed into floating resorts, offering passengers numerous and myriad forms of entertainment ranging from live music to shopping to bingo. Cruise lines consistently vie customers and market position by attempting to offer the most appealing combination of entertainment activities. As such, popular and exciting activities are constantly being added to the available roster of cruise ship entertainment options.

Also in recent years, karaoke has developed into a worldwide entertainment phenomenon, with karaoke boxes and bars found in most major metropolitan areas and karaoke being offered in video games and even mobile phones. In karaoke, one or more amateur singers sing along with recorded music on microphone. Normally, the music used in karaoke is a popular song, which has had the vocal track either reduced in volume or removed altogether. Typically, the lyrics of the song are displayed in a manner such that the singers can follow along appropriately.

As karaoke has grown in popularity and cruise lines are constantly searching for entertainment options that will provide an edge in the search for customers, there exists a need to provide karaoke as a form of entertainment upon a cruise ship. It is the object of this invention to meet that need.

### SUMMARY OF THE INVENTION

The present invention relates to an onboard karaoke system comprising one or more of a soundproof cube, a karaoke machine, a sound system, a video camera, a seating area, a lighting system, and a second video screen. The karaoke machine further comprises a first video screen, a device for synchronized audio/video playback, and a microphone. In one embodiment, the onboard karaoke system is located on a ship.

In a further embodiment of the onboard karaoke system, the second video screen provides real-time control of one or more karaoke machines, the sound system, the video camera and the lighting system. In one embodiment, the second video screen also provides real-time menu selection for food and drink. In another embodiment, the second video screen also provides contact with support staff.

In a further embodiment, the onboard karaoke system further comprises a soundproof cube sized to accommodate up to 6 persons or more. In vet another embodiment, the soundproof cube is fitted with wheels for portability. In a further embodiment the soundproof cube is waterproofed to allow for placement of the karaoke box on the deck of a ship. In one embodiment, the soundproof cube comprises soundproof walls, a soundproof floor, a soundproof ceiling and a soundproof door. In a further embodiment, the first video monitor is equipped with a touch screen. In vet another embodiment the second video, monitor is equipped with a touch screen. In one embodiment of the present invention, the invention is located on a cruise ship.

The present invention provides a method for onboard karaoke comprising using or providing the onboard karaoke system. In a further embodiment, the present invention includes a method for onboard karaoke comprising providing an onboard karaoke system on a ship, and the onboard karaoke system comprises one or more of a soundproof cube, a karaoke machine, a video camera, a seating area, a lighting system, and a second video screen.

In yet another embodiment, the karaoke machine comprises one or more of a first video screen, a device for synchronized audio/video playback, and a microphone, a sound system. The second video screen provides real-time control of one or more of said karaoke machine, said sound system, said video camera, and said lighting system. The second video screen additionally provides real-time menu selection for food and drink.

In another embodiment, the soundproof cube is sized to accommodate up to 6 persons. In yet another embodiment the soundproof cube comprises soundproof walls, a soundproof floor, a soundproof ceiling, and a soundproof door. The first and second video monitor may additionally be equipped with a touch screen. The present invention may also provide a method for onboard karaoke where the ship is a cruise ship.

### BRIEF DESCRIPTION OF THE DRAWINGS

The present invention in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram of one specific embodiment of an onboard karaoke system.

The figures are not intended to be exhaustive or to limit the invention to the precise form disclosed. It should be understood that the invention can be practiced with modification and alteration, and that the invention be limited only by the embodiments and the equivalents thereof.

### DETAILED DESCRIPTION OF THE EMBODIMENTS

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

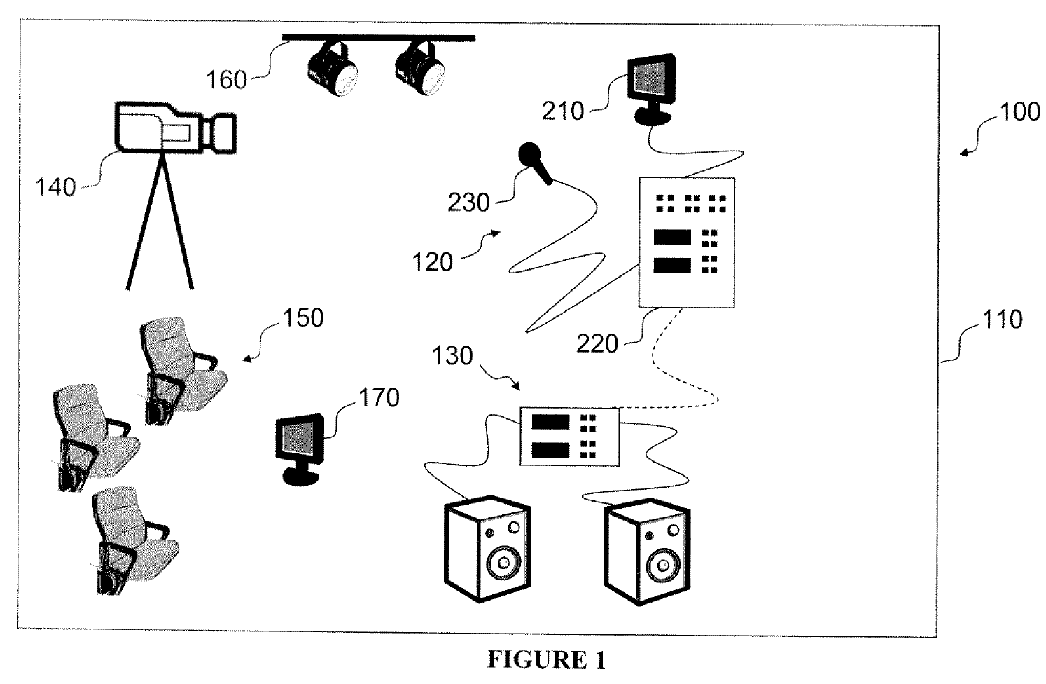

FIG. 1 illustrates one specific embodiment of an onboard karaoke system of the present invention. As shown in FIG. 1, onboard karaoke system 100 may comprise one or more of soundproof cube 110, karaoke machine 120, sound system 130, video camera 140, seating area 150, lighting system 160, and video screen 170. Advantageously, in specific embodiments, onboard karaoke system 100 may be located upon a ship.

In specific embodiments, soundproof cube 110 may contain karaoke machine 120, sound system 130, video camera 140, seating area 150, lighting system 160, and video screen 170, Soundproof cube 110 may, in certain embodiments, be a shape other than a cube. In specific embodiments, soundproof cube 110 may comprise a soundproof floor, soundproof walls, a soundproof ceiling, and a soundproof door. In another specific embodiment, soundproof cube 110 may be fitted with wheels such that it may be moved from place to place. In vet another specific embodiment, soundproof cube 110 may be waterproofed in a manner such that it may be placed upon the deck of a ship, Soundproof cube 110 may also comprise one or more transparent walls.

In specific embodiments, soundproof cube 110 may advantageously be designed to prevent, or allow, sounds generated from within soundproof cube 110 from being heard outside of soundproof cube 110, as well as prevent sounds generated outside soundproof cube 110 from being heard within soundproof cube 110. This design advantageously allows those participating in the karaoke to avoid outside distractions, and prevents those not participating from hearing the cacophony that can at times be generated during a boisterous karaoke session.

In specific embodiments, soundproof cube 110 may comprise windows, glass walls, doors, or other openings such that those outside of soundproof cube 110 may see those within soundproof cube 110 and those within soundproof cube 110 may see those outside of soundproof cube 110. This is advantageous, as it allows those outside soundproof cube 110 to be enticed into participating in karaoke by seeing how much fun is being had within soundproof cube 110.

In other specific embodiments, soundproof cube may prevent substantially all sounds generated from within soundproof cube 110 from being heard outside of soundproof cube 110, as well as prevent substantially all sounds generated outside soundproof cube 110 from being heard within soundproof cube 110. In specific embodiments, soundproof cube 110 may use the commonly known soundproofing techniques known as damping and noise cancellation.

In a specific embodiment, karaoke machine 120 may comprise one or more of video monitor 210, synchronized player 220, and microphone 230. In specific embodiments, video monitor 210 may comprise a television monitor, a computer monitor, an LCD monitor, a CRT monitor, an LCoS monitor, a DLP monitor, a plasma monitor, or any other monitor as understood by one of skill in the art. In a specific embodiment, video monitor 210 may be equipped with a touch screen.

In specific embodiments, synchronized player 220 may be advantageously designed to facilitate synchronized audio/playback. In some specific embodiments, what is meant by synchronized audio/video playback is the playing of music (normally a popular song with the vocal track either reduced in volume or removed altogether) at the same time as displaying the lyrics to the music. In specific embodiments, the music is played through sound system 130 and the lyrics are displayed on video monitor 210. In this manner, the karaoke singer may read the lyrics as they are displayed on video monitor 210 and sign along, into microphone 230, with the music playing through sound system 130. Microphone 230 may comprise one of any number of commercially available microphones, or any microphone as understood by one of skill in the art.

In specific embodiments, video monitor 210, synchronized player 220, and microphone 230 may be connected to each other via a wireless communications link, a wired communications link, or some combination or variation thereof as understood by one skilled in the art.

In specific embodiments, video camera 140 may comprise one of any number of commercially available video cameras, or any video camera as understood by one of skill in the art. In specific embodiments, video camera 140 may comprise a digital video recording device, and in other embodiments, video camera 140 may comprise an analog video recording device. In specific embodiments, video camera 140 may allow video of the karaoke singer to be recorded for later playback. In other embodiments, video camera 140 may allow video of the karaoke singer to be broadcast on video screen 210, video screen 170, or some other video screen. The video made, can be provided as a prize or sold.

Advantageously, in specific embodiments, seating area 150 is provided to allow others to view the karaoke singer perform. In specific embodiments, seating area 150 is provided to allow the karaoke singer to sit in between performances, or for a group of people to take turns sitting and performing karaoke. In specific embodiments, seating area 150 may comprise one or more chairs benches, loveseats sofas, or any other type if seating as understood by one of skill in the art.

In specific embodiments, lighting system 160 is provided. Lighting system 160 maw be comprised of one of any number of commercially available lighting sources, or any other lighting source as understood by one of skill in the art. In specific embodiment, lighting system 160 may be used in conjunction with video camera 140 such that any recorded video of the karaoke singer is adequately lit. In specific embodiments, lighting system 140 may comprise one or more colored lamps, a laser system, a disco ball, any other form of entertainment lighting, or any combination thereof.

In specific embodiments, video monitor 170 may comprise a television monitor, a computer monitor, an LCD monitor, a CRT monitor, an LCoS monitor, a DLP monitor, a plasma monitor, or any other monitor as understood by one of skill in the art. In a specific embodiment, video monitor 170 may be equipped with a touch screen. Advantageously in specific embodiments, video monitor 170 may provide control of one or more of karaoke machine 120, sound system 130, video camera 140, and lighting system 160. In specific embodiments, video monitor 170 may provide menu selection such that the karaoke participants and observers can order food and drink. In other specific embodiments, video monitor 170 may provide contact with support staff, such that any technical or other problems may be resolved in a timely fashion without undue burden on the karaoke participants.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to

I claim:

1. An onboard karaoke system comprising:
a soundproof cube;
a karaoke machine comprising
a first video screen,
a device for synchronized audio/video playback, and
a microphone;
a sound system;
a video camera;
a seating area;
a lighting system; and
a second video screen,
wherein said onboard karaoke system is located upon a ship.

2. The onboard karaoke system of claim 1, wherein said second video screen provides real-time control of one or more of said karaoke machine, said sound system, said video camera and said lighting system.

3. The onboard karaoke system of claim 1, wherein said second video screen provides real-time menu selection for food and drink.

4. The onboard karaoke system of claim 1, wherein said second video screen provides contact with support staff.

5. The onboard karaoke system of claim 1, wherein said soundproof cube is sized to accommodate up to 6 persons.

6. The onboard karaoke system of claim 1, wherein said soundproof cube is fitted with wheels for portability.

7. The onboard karaoke system of claim 1, wherein said soundproof cube is waterproofed to allow for placement of the karaoke box on the deck of a ship.

8. The onboard karaoke system of claim 1, wherein said soundproof cube comprises soundproof walls, a soundproof floor, a soundproof ceiling, and a soundproof door.

9. The onboard karaoke system of claim 1, wherein said first video monitor is equipped with a touch screen.

10. The onboard karaoke system of claim 1, wherein said second video monitor is equipped with a touch screen.

11. The onboard karaoke system of claim 1, wherein said ship is a cruise ship.

12. A method for onboard karaoke comprising using the system of claim 1.

13. A method for onboard karaoke comprising providing an onboard karaoke system on a ship, said onboard karaoke system comprising:
a soundproof cube;
a karaoke machine comprising
a first video screen,
a device for synchronized audio/video playback, and
a microphone;
a sound system;
a video camera;
a seating area;
a lighting system; and
a second video screen.

14. The method of claim 13, wherein said second video screen provides real-time control of one or more of said karaoke machine, said sound system, said video camera and said lighting system.

15. The method of claim 13, wherein said second video screen provides real-time menu selection for food and drink.

16. The method of claim 13, wherein said soundproof cube is sized to accommodate up to 6 persons.

17. The method of claim 13, wherein said soundproof cube comprises soundproof walls, a soundproof floor, a soundproof ceiling, and a soundproof door.

18. The method of claim 13, wherein said first video monitor is equipped with a touch screen.

19. The method of claim 13, wherein said second video monitor is equipped with a touch screen.

20. The method of claim 13, wherein said ship is a cruise ship.
